(19) United States
(12) Patent Application Publication
(10) Pub. No.: US 2008/0038557 A1
(43) Pub. Date: Feb. 14, 2008

(54) Process for making collapsible water-containing capsules

(75) Inventors: Takashi Sako, Kobe (JP); Kojo Tanaka, Ashiya (JP); Takahiro Nakajima, Kobe (JP)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/890,363

(22) Filed: Aug. 6, 2007

Related U.S. Application Data
(60) Provisional application No. 60/836,430, filed on Aug. 8, 2006.

(51) Int. Cl. B32B 3/26

(52) U.S. Cl. 428/402.2; 264/4.1

(57) ABSTRACT

Disclosed are processes for making a collapsible water-containing capsule having a water phase encapsulated or dispersed in a pigment phase, the pigment phase comprising at least a first pigment component having a particle size of less than 1 μm and a hydrophobic surface; wherein the water phase and the pigment phase is mixed by a mixing apparatus such as external energy sourcing type and container shaking type, fluidizer type, mechanical mixing type and container rotating type. Also disclosed are products made by the processes above. Also disclosed are preparation-at-use products for providing a collapsible water-containing capsule.

### CROSS REFERENCE TO RELATED APPLICATIONS

This application claims the benefit of U.S. Provisional Application No. 60/836,430 filed on Aug. 8, 2006.

### FIELD OF THE INVENTION

The present invention relates to a process for making a collapsible water-containing capsule having water encapsulated or dispersed in hydrophobic pigments. The present invention further relates to capsules made by such process.

### BACKGROUND

A foundation composition can be applied to the face and other parts of the body to even skin tone and texture and to hide pores, imperfections, fine lines and the like. A foundation composition is also applied to moisturize the skin, to balance the oil level of the skin, and to provide protection against the adverse effects of sunlight, wind, and other environmental factors.

Foundation compositions are generally available in the form of liquid or cream suspensions, emulsions, gels, pressed powders, loose powders or anhydrous oil and wax compositions. Emulsion-type foundations are suitable in that they provide moisturizing effects by the water and water-soluble skin treatment agents incorporated. On the other hand, a larger amount and variation of powders and pigments can be formulated into pressed powders and loose powders.

Recently, consumers who seek moisturization as well as the ideal look having both good coverage and natural look on the skin, have the habit of a two step regimen of foundation application. The two step regimen typically contains application of a liquid or emulsion form foundation followed by a pressed or loose powder foundation. It is conceived by such demanding consumers that such two-step regimen provides best results, however, such regimen is also quite elaborate. There is a need for a foundation product which can provide both good feel and good appearance on the skin, and also being easy to apply on the skin.

Meanwhile, collapsible water-containing capsules are known in the art, such as in WO 01/85138, Japanese Patent Publications 2001-131528A, 2000-247823A, 2000-309506A, 11-130614A, 10-265367A, 5-65212A, 4-308520A, 2006-509732A, 2001-226230A, 2001-158716A, and 1-125314A. Such capsules provide a unique feel or change of feel upon application and collapsing on the skin. Upon application to the skin, such capsules provide a moisturizing or fresh feeling. Such capsules may also deliver water-soluble skin active agents such as vitamin C derivatives to the skin, in a more or less stable manner. The collapsible water-containing capsules form may be adopted for foundations having such benefits.

Due to the physical composition of such collapsible water-containing capsules, the process for making these capsules require careful handling such that the capsules are formed at a high yield without destroying the physical structure. Processes for making such collapsible water-containing capsules are known in the art, such as in WO 02/05844, WO 01/85138, and Japanese Patent Publications 2006-509732A, and 2001-131528A.

None of the above mentioned references, however, disclose a process which allows effective making of capsules which provide good feel to the personal surface, and further maintains the physical structures of the capsules.

Based on the foregoing, there is a need for a process for making a collapsible water-containing capsule in an effective manner, the wherein the capsule provides good feel to the personal surface. While such benefit is believed to be useful for making capsules that are foundations, it is also believed that the same is true for other personal care compositions.

None of the existing art provides all of the advantages and benefits of the present invention.

### SUMMARY

The present invention is directed to a process for making a collapsible water-containing capsule having a water phase encapsulated or dispersed in a pigment phase, the pigment phase comprising at least a first pigment component having a particle size of less than 1 μm and a hydrophobic surface;

wherein the water phase and the pigment phase is mixed by a mixing apparatus selected from the group consisting of external energy sourcing type and container shaking type.

The present invention is also directed to a process for making a collapsible water-containing capsule having a water phase encapsulated or dispersed in a pigment phase, the pigment phase comprising at least a first pigment component having a particle size of less than 1 μm and is surface coated with a lipophobic hydrophobic coating material;

wherein the water phase and the pigment phase is mixed by a mixing apparatus selected from the group consisting of fluidizer type, mechanical mixing type and container rotating type.

The present invention is also directed to products made by the processes above.

The present invention is also directed to a preparation-at-use product for providing a collapsible water-containing capsule.

These and other features, aspects, and advantages of the present invention will become evident to those skilled in the art from a reading of the present disclosure with the appended claims.

### DETAILED DESCRIPTION

While the specification concludes with claims particularly pointing out and distinctly claiming the invention, it is believed that the present invention will be better understood from the following description.

All percentages, parts and ratios are based upon the total weight of the compositions of the present invention, unless otherwise specified. All such weights as they pertain to listed ingredients are based on the active level and, therefore, do not include carriers or by-products that may be included in commercially available materials.

All ingredients such as actives and other ingredients useful herein may be categorized or described by their cosmetic and/or therapeutic benefit or their postulated mode of action. However, it is to be understood that the active and other ingredients useful herein can, in some instances, provide more than one cosmetic and/or therapeutic benefit or operate via more than one mode of action. Therefore, classifications herein are made for the sake of convenience and are not intended to limit an ingredient to the particularly stated application or applications listed.

### Collapsible Water-Containing Capsule

The present invention relates to making a collapsible water-containing capsule which comprises, by weight of the capsule, at least about 60%, preferably from about 70% to about 92% of a water phase, the water phase being water and optional water-soluble solvents. To hold such abundant amount of water in the structure, the capsule of the present invention comprises a pigment phase, the pigment phase comprising at least a first pigment component having a particle size of less than 1 μm and a hydrophobic surface, in which the water is encapsulated or dispersed. The process preferably provides a capsule which is stable under normal storage conditions as well as normal mixing processes, however, collapses upon application.

In one preferred embodiment, such stability for the capsule is provided by further comprising, in the present capsule, a gelling agent, and a second pigment component in the pigment phase. Without being bound by theory, it is believed that the gelling agent holds the water phase in a relatively rigid structure, while the first and second pigment components cover the water phase and thereby provide the stability and integrity of the capsule. Herein, the first pigment component and optional second pigment components are collectively referred to as “the pigment phase”. Pigments and powders which do not meet the criteria for the first or second pigment component are not referred to as the pigment phase.

In one preferred embodiment, the capsule of the present invention is substantially free of surfactant. Without being bound by theory, it is believed that surfactants may negatively affect the stability and shear stress tolerance of the present capsule by decreasing the surface tension difference between the water phase and the pigment phase. Herein, surfactants include those which have detersive capability, as well as those which only act as emulsifiers for emulsifying water and oil phases.

In one preferred embodiment, the capsule of the present invention comprises less than 1% of porous pigments having a particle size of less than 1 μm. Without being bound by theory, it is believed that porous pigments of small size may absorb sebum from the personal surface to such an extent that a dry negative feeling is provided to the personal surface. Herein, porous pigments include silica, aluminum oxide, calcium carbonate, cellulose, and others that may have a porous structure when observed under magnification. It is noted that pigments made from the same chemical compound may take either a porous or non-porous structure, based on the process it is purified, processed, synthesized, or otherwise treated.

The capsule of the present invention provides unique benefits on the personal surface, such as skin, hair, or scalp, when collapsed on the surface. It provides a fresh or cooling feel to the surface, by releasing the abundant water. In preferred embodiments, the capsule provides an initially fresh, and then moisturizing feel to the surface. The preferred embodiment capsule further provides a good feel to the surface by the characteristic of the first and/or second pigment components. When the first and second pigment components are applied on the surface, the components provide the appearance benefits inherent of such pigment components. The capsule of the present invention may, by itself, provide a product in the form of a loose powder product. The capsule of the present invention may also be mixed with other components to provide different product forms.

The capsule of the present invention is particularly useful for personal care compositions for delivering water, the pigments, and other components to the personal surface. Personal care compositions herein include those for the purpose of skin care, make-up, extensive treatment, perfume, antiperspiration, deodorizing, hair coloring, hair treatment, hair styling, and others. Personal care compositions herein can take the product form of powders, wax solidified solid forms, liquids, lotions, pastes, aerosols, and others. One highly preferred product form embodiment is powder for use on the skin, such as foundation and skin care products. For such personal care compositions, the first pigment component and optional second pigment component are selected to provide the appropriate skin treatment and/or make-up benefits. In one highly preferred embodiment, the capsule comprises by weight:
(a) from about 70% to about 92% of a water phase comprising, by weight of the capsule:

(1) from about 5% to about 91.9% water; and

(2) from about 0.1% to about 20% of a gelling agent;
(b) from about 1% to about 29.9% of a first pigment component which has a particle size of less than 1 μm and is surface coated with a lipophobic hydrophobic coating material; and
(c) from about 0.1% to about 29% of a second pigment component which has a particle size of 1 μm or more, is surface coated with a hydrophobic coating material; and is spherical in shape;
   wherein the total of the first pigment component and the second pigment component is at least about 8% of the capsule; and
   wherein the capsule comprises less than 1% of a porous pigment having a particle size of less than 1 μm.

### Water Phase

The capsule of the present invention comprises a water phase, the water phase comprising water, and optional water-soluble solvent detailed hereafter. The present capsule comprises, by weight of the capsule, at least from about 60%, preferably from about 70% to about 92% of the water phase. The water phase may be made only by water. Preferably, water is contained at from about 5% to about 91.9% of the capsule. Deionized water is preferably used. Water from natural sources including mineral cations can also be used, depending on the desired characteristic of the product. In one preferred embodiment, water may be sourced from fermented biological cultures or its filtrates. A highly preferred commercial source of this kind is Saccharomycopsis ferment filtrate by the tradename SK-II Pitera available from Kashiwayama.

The pH of the water phase is selected in view of the desired characteristic of the product, and particularly, when skin benefit agents are included, the activity and stability of the skin benefit agents. In one preferred embodiment the pH is adjusted from about 4 to about 8. Buffers and other pH adjusting agents can be included to achieve the desirable pH.

### Water-Soluble Solvent

The water phase of the capsule of the present invention may further comprise a water-soluble solvent selected from lower alkyl alcohols and water-soluble humectants. The water-soluble solvents are selected according to the desired skin feel to be delivered, and/or for delivering certain skin benefit agents.

Lower alkyl alcohols useful herein are monohydric alcohols having 1 to 6 carbons, more preferably ethanol and isopropanol.

Water soluble humectants useful herein include polyhydric alcohols such as butylene glycol (1,3-butanediol), pentylene glycol (1,2-pentanediol), glycerin, sorbitol, propylene glycol, hexylene glycol, ethoxylated glucose, 1,2-hexane diol, 1,2-pentane diol, hexanetriol, dipropylene glycol, erythritol, trehalose, diglycerin, xylitol, maltitol, maltose, glucose, fructose; and other water-soluble compounds such as urea, sodium chondroitin sulfate, sodium hyaluronate, sodium adenosin phosphate, sodium lactate, pyrrolidone carbonate, glucosamine, cyclodextrin, and mixtures thereof. Also useful herein include water soluble alkoxylated nonionic polymers such as polyethylene glycols and polypropylene glycols having a molecular weight of up to about 1000 such as those with CTFA names PEG-200, PEG-400, PEG-600, PEG-1000, and mixtures thereof.

In one preferred embodiment, the present capsule comprises from about 1% to about 30% of a water-soluble humectant. In one highly preferred embodiment wherein the capsule is used as a foundation, the capsule comprises from about 3% to about 30% of a water-soluble humectant.

Commercially available humectants herein include: butylene glycol with tradename 1,3-Butylene Glycol available from Celanese, pentylene glycol with tradename HYDROLITE-5 available from Dragoco, glycerin with tradenames STAR and SUPEROL available from The Procter & Gamble Company, CRODEROL GA7000 available from Croda Universal Ltd., PRECERIN series available from Unichema, and a same tradename as the chemical name available from NOF; propylene glycol with tradename LEXOL PG-865/855 available from Inolex, 1,2-PROPYLENE GLYCOL USP available from BASF; sorbitol with tradenames LIPONIC series available from Lipo, SORBO, ALEX, A-625, and A-641 available from ICI, and UNISWEET 70, UNISWEET CONC available from UPI; dipropylene glycol with the same tradename available from BASF; diglycerin with tradename DIGLYCEROL available from Solvay GmbH; xylitol with the same tradename available from Kyowa and Eizai; maltitol with tradename MALBIT available from Hayashibara, sodium chondroitin sulfate with the same tradename available from Freeman and Bioiberica, and with tradename ATOMERGIC SODIUM CHONDROITIN SULFATE available from Atomergic Chemetals; sodium hyaluronate available from Chisso Corp, the same with tradenames ACTIMOIST available from Active Organics, AVIAN SODIUM HYALURONATE series available from Intergen, HYALURONIC ACID Na available from Ichimaru Pharcos; sodium adenosin phophate with the same tradename available from Asahikasei, Kyowa, and Daiichi Seiyaku; sodium lactate with the same tradename available from Merck, Wako, and Showa Kako, cyclodextrin with tradenames CAVITRON available from American Maize, RHODOCAP series available from Rhone-Poulenc, and DEXPEARL available from Tomen; and polyethylene glycols with the tradename CARBOWAX series available from Union Carbide.

### Gelling Agents

The collapsible water-containing capsule of the present composition may further comprise, by weight of the capsule, from about 0.1% to about 20%, preferably from about 0.1% to about 5%, of a gelling agent which, when mixed with the water phase, provides an aqueous composition having a viscosity of from about 10 mPas to about 1,000,000 mPas, preferably from about 10 mPas to about 100,000 mPas. Incorporation of a gelling agent is advantageous, in that the gelling agent holds the water phase in a relatively rigid structure, and thereby believed to provide improved stability and integrity of the capsule.

The polymers useful as the gelling agent herein are water soluble or water miscible polymers. The term “water soluble or water miscible” with regard to the gelling agents herein, relate to compounds that are dissolved to make a transparent solution when dissolved in ample amount of water with or without the aid of elevated temperature and/or mixing.

Useful herein are starch derivative polymers such as carboxymethyl starch, and methylhydroxypropyl starch. Commercially available compounds that are highly useful herein include sodium carboxymethyl starch with tradename COVAGEL available from LCW.

Useful herein are cellulose derivative polymers. Cellulose derivative polymers useful herein include methylcellulose, ethylcellulose, hydroxyethylcellulose, hydroxyethyl ethylcellulose, hydroxypropyl methyl cellulose, nitrocellulose, sodium cellulose sulfate, sodium carboxymethylcellulose, crystalline cellulose, cellulose powder, and mixtures thereof. Also useful are starch derivative polymers such as carboxymethyl starch, and methylhydroxypropyl starch. Commercially available compounds that are highly useful herein include hydroxyethylcellulose with tradename Natrosol Hydroxyethylcellulose, and carboxymethylcellulose with tradename Aqualon Cellulose Gum, both available from Aqualon.

Useful herein are carboxylic acid/carboxylate copolymers. Commercially available carboxylic acid/carboxylate copolymers useful herein include: CTFA name Acrylates/C10-30 Alkyl Acrylate Crosspolymer having tradenames Pemulen TR-1, Pemulen TR-2, Carbopol 1342, Carbopol 1382, and Carbopol ETD 2020, all available from B. F. Goodrich Company.

Neutralizing agents may be included to neutralize the carboxylic acid/carboxylate copolymers herein. Nonlimiting examples of such neutralizing agents include sodium hydroxide, potassium hydroxide, ammonium hydroxide, monoethanolamine, diethanolamine, triethanolamine, diisopropanolamine, aminomethylpropanol, tromethamine, tetrahydroxypropyl ethylenediamine, and mixtures thereof.

Polyalkylene glycols having a molecular weight of more than about 1000 are useful herein. Useful are those having the following general formula:

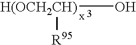

wherein R⁹⁵ is selected from the group consisting of H, methyl, and mixtures thereof. When R⁹⁵ is H, these materials are polymers of ethylene oxide, which are also known as polyethylene oxides, polyoxyethylenes, and polyethylene glycols. When R⁹⁵ is methyl, these materials are polymers of propylene oxide, which are also known as polypropylene oxides, polyoxypropylenes, and polypropylene glycols. When R⁹⁵ is methyl, it is also understood that various positional isomers of the resulting polymers can exist. In the above structure, x3 has an average value of from about 1500 to about 25,000, preferably from about 2500 to about 20,000, and more preferably from about 3500 to about 15,000. Other useful polymers include the polypropylene glycols and mixed polyethylene-polypropylene glycols, or polyoxyethylene-polyoxypropylene copolymer polymers. Polyethylene glycol polymers useful herein are PEG-2M wherein R⁹⁵ equals H and x3 has an average value of about 2,000 (PEG-2M is also known as Polyox WSR® N-10, which is available from Union Carbide and as PEG-2,000); PEG-5M wherein R⁹⁵ equals H and x3 has an average value of about 5,000 (PEG-5M is also known as Polyox WSR® N-35 and Polyox WSR® N-80, both available from Union Carbide and as PEG-5,000 and Polyethylene Glycol 300,000); PEG-7M wherein R⁹⁵ equals H and x3 has an average value of about 7,000 (PEG-7M is also known as Polyox WSR® N-750 available from Union Carbide); PEG-9M wherein R⁹⁵ equals H and x3 has an average value of about 9,000 (PEG 9-M is also known as Polyox WSR® N-3333 available from Union Carbide); and PEG-14 M wherein R⁹⁵ equals H and x3 has an average value of about 14,000 (PEG-14M is also known as POLYOX WSR® N-3000 available from Union Carbide).

Useful herein are vinyl polymers such as cross linked acrylic acid polymers with the CTFA name Carbomer, pullulan, mannan, scleroglucans, polyvinylpyrrolidone, polyvinyl alcohol, guar gum, hydroxypropyl guar gum, xanthan gum, acacia gum, arabia gum, tragacanth, galactan, carob gum, karaya gum, locust bean gum, carrageenin, pectin, amylopectin, agar, quince seed (Cyclonia oblonga Mill), starch (rice, corn, potato, wheat), algae colloids (algae extract), microbiological polymers such as dextran, succinoglucan, starch-based polymers such as carboxymethyl starch, methylhydroxypropyl starch, alginic acid-based polymers such as sodium alginate, alginic acid propylene glycol esters, acrylate polymers such as sodium polyacrylate, polyacrylamide, polyethyleneimine, and inorganic water soluble material such as bentonite, aluminum magnesium silicate, laponite, hectonite, and anhydrous silicic acid.

Commercially available gelling agents useful herein include xanthan gum with tradename KELTROL series available from Kelco, Carbomers with tradenames CARBOPOL 934, CARBOPOL 940, CARBOPOL 950, CARBOPOL 980, and CARBOPOL 981, all available from B. F. Goodrich Company, agar with tradename INA AGAR available from Ina Food, acrylates/steareth-20 methacrylate copolymer with tradename ACRYSOL 22 available from Rohm and Hass, polyacrylamide with tradename SEPIGEL 305 available from Seppic, glyceryl polymethacrylate with tradename LUBRAGEL NP, and a mixture of glyceryl polymethacrylate, propylene glycol and PVM/MA copolymer with tradename LUBRAGEL OIL available from ISP, scleroglucan with tradename Clearogel SC11 available from Michel Mercier Products Inc. (NJ, USA), ethylene oxide and/or propylene oxide based polymers with tradenames CARBOWAX PEGs, POLYOX WASRs, and UCON FLUIDS, all supplied by Amerchol.

Useful herein are amphoteric polymers such as Polyquaternium 22 with tradenames MERQUAT 280, MERQUAT 295, Polyquaternium 39 with tradenames MERQUAT PLUS 3330, MERQUAT PLUS 3331, and Polyquaternium 47 with tradenames MERQUAT 2001, MERQUAT 2001N, all available from Calgon Corporation. Other useful amphoteric polymers include octylacrylamine/acrylates/butylaminoethyl methacrylate copolymers with the tradenames AMPHOMER, AMPHOMER SH701, AMPHOMER 28-4910, AMPHOMER LV71, and AMPHOMER LV47 supplied by National Starch & Chemical.

### First Pigment Component

The collapsible water-containing capsule of the present composition comprises a pigment phase comprising at least a first pigment component having a particle size of less than 1 μm, preferably from about 5 nm to about 600 nm, more preferably from about 10 nm to about 500 nm. The first pigment component has a hydrophobic surface, meaning the first pigment component is inherently hydrophobic, or hydrophobically surface coated, preferably surface coated with a lipophobic hydrophobic coating material. For providing a preferred stable composition, the first pigment component is comprised, by weight of the capsule, from about 1% to about 29.9%, more preferably from about 6% to about 27%, of the capsule.

In one preferred embodiment, the first pigment component is surface coated with a lipophobic hydrophobic coating material. Without being bound by theory, in such preferred embodiment, it is believed that, by the surface tension of the lipophobic hydrophobic surface of the first pigment component, the first pigment component aligns at the phase boundary of the water phase, while the particles of the first pigment component bind with each other via van-der-Waals binding. Hence, the first pigment component covers the water phase. It is further believed that the overall structure due to the lipophobic hydrophobic surface, combined with the relatively small particle size of the first pigment component, contributes to the suitable shear stress tolerance of the collapsible water-containing capsule of the present composition.

The base pigments of the first pigment component useful herein include those that provide color or change tone, and also those that provide a certain skin feel. Useful pigments herein include clay mineral powders such as talc, magnesium silicate, synthetic fluorphlogopite, calcium silicate, aluminum silicate, silicate, bentonite and montomorilonite. The coloring powders useful herein include pearl pigments such as alumina, barium sulfate, calcium secondary phosphate, zirconium oxide, zinc oxide, hydroxy apatite, iron oxide, iron titate, ultramarine blue, Prussian blue, chromium oxide, chromium hydroxide, cobalt oxide, cobalt titanate, titanium oxide coated mica; organic powders such as polyester, polyethylene, polypropylene, polystyrene, methyl metharylate copolymer, cross-linked polymethyl methacrylate, 12-nylon, 6-nylon, polystyrene, styrene-acrylic acid copolymers, vinyl chloride polymer, vinyl acetates, tetrafluoroethylene polymer, polyorganosilsesquioxane resins, solid silicone elastomers, boron nitride, fish scale guanine, laked tar color dyes, and laked natural color dyes. Particularly useful herein as the first pigment component are titanium dioxide, zinc oxide, iron oxide, barium sulfate, polystyrene, silicate, and mixtures thereof.

When the first pigment component is not inherently hydrophobic, the surface is coated with materials having hydrophobic characteristics. Useful hydrophobic coating materials herein include organic silicone compounds, metal soap, oils, and material having both lipophobic and hydrophobic characteristics, such as fluorine compounds. Particularly suitable fluorine compounds herein are selected from the group consisting of perfluorooctyl triethoxylsilane, perfluoroalkylphosphoric acids, their salts, and mixtures thereof.

Commercially available first pigment components highly useful herein include Titanium Dioxide coated with C9-15 fluoroalcohol phosphates (0.25 μm) with tradename PF-5 TiO2 CR-50, Titanium Dioxide coated with perfluorooctyl triethoxysilane (0.021 μm) with tradename FHS—12 TiO2 P-25, Zinc Oxide coated with C9-15 fluoroalcohol phosphates (0.020 μm) with tradename PF-7 ZnO-350, Yellow Iron Oxide coated with C9-15 fluoroalcohol phosphates (0.435 μm) with tradename PF-5 YELLOW LL-100PD, Red Iron Oxide coated with C9-15 fluoroalcohol phosphates (0.44 μm) with tradename PF-5 RED R-516PD, and Black Iron Oxide coated with C9-15 fluoroalcohol phosphates (0.4 μm) with tradename PF-5 BLACK BL-100P PF-5 BLACK BL-100P PF-5 BLACK BL-100P, all available from Daito Kasei, hydrophobic silicates with tradename AEROSIL RY200S, AEROSIL R202, AEROSIL 805, AEROSIL R812S, AEROSIL 917, AEROSIL 974, AEROSIL 972, AEROSIL RX200, AEROSIL RX300, all available from Nippon Aerosil, and CAB-O-SIL TS530, CAB-O-SIL TS720, all available from Cabot Corporation.

### Second Pigment Component

In one preferred embodiment, the pigment phase further comprises, by weight of the capsule, from about 0.1% to about 29%, preferably from about 1% to about 10%, of a second pigment component. The second pigment component herein has a particle size of 1 μm or more, preferably from about 1 μm to about 25 cm, more preferably from about 4 μm to about 15 μm, and is surface coated with a hydrophobic coating material. The second pigment component has a more or less spherical shape. Without being bound by theory, it is believed that, by the larger size of the second pigment component, the second pigment component aligns at the phase boundary of the first pigment component. It is believed that the dual covered structure provided by the first and second pigment components provide the suitable shear stress tolerance of the collapsible water-containing capsule of the present composition. It is believed that pigments having spherical shape are advantageous.

When included, the total of the first pigment component and the second pigment component is at least about 8% of the capsule, preferably from about 8% to about 26% of the capsule.

When included, the second pigment component also provides a unique appearance effect or skin feel that is not easily delivered by the first pigment component. In one example, the first pigment components alone may provide an overly matte finish and emphasize, rather than hide, skin unevenness such as pores. A spherical and translucent second pigment component can improve the natural appearance by light diffusion effect due to its shape and translucency. In another example, the first pigment components alone may provide a squeaky feel on the skin due to their small size. A soft spherical second pigment component may alleviate such negative skin feel and provide good smooth feel.

The base pigments of the second pigment component useful herein include; polyacrylates, silicates, sulfates, alumina, metal dioxides, carbonates, celluloses, polyalkylenes, vinyl acetates, polystyrenes, polyamides, acrylic acid ethers, silicones, mica, and mixtures and complexes thereof. Specifically, materials useful herein include polyacrylates such as methyl methacrylate copolymer and nylon, cross linked polymethyl methacrylate; silicates such as calcium silicate, magnesium silicate, barium silicate, aluminium silicate and silica beads; alumina; metal dioxides such as titanium dioxide and aluminium hydroxide; carbonates such as calcium carbonate, magnesium carbonate; celluloses; polyalkylenes such as polyethylene, and polypropylene; vinyl acetates; polystyrenes; polyamides; acrylic acid ethers such as acrylic acid methyl ether and acrylic acid ethyl ether; polyvinyl pyrrolidones; and silicones such as polyorganosilsesquioxane resin and solid silicone elastomers. Highly preferred materials are polymethyl methacylate.

In one embodiment, polyorganosilsesquioxane resin and solid silicone elastomers may be used for enhancing the effect of hiding skin pores.

The second pigment component herein is surface coated with a coating material having hydrophobic characteristics, whereby lipophobic hydrophobic coating materials are preferred. Useful hydrophobic coating materials herein include methyl polysiloxane, methyl hydrogen polysiloxane, methyl phenyl polysilxoane, n-octyl triethoxy silane, methyl-alpha-styrene polysiloxane, acryl silicone copolymer, and mixtures thereof. Preferred lipophobic hydrophobic coating materials are the same coating material as aforementioned for the first pigment component.

Commercially available second pigment components highly useful herein include mica (10 cm) with tradename SERICITE FSE available from Sanshin Kohkoh. Commercially available spherical second pigment components highly useful herein include methyl methacylate copolymer with tradename GANZ PEARL series available from Ganz Chemical Co., Ltd., and SYLYSIA series available from Fuji Sylysia Chemical, Nylon-12 with tradename NYLON POWDER series available from Toray Dow Corning, Nylon-12 coated with C9-15 fluoroalcohol phosphates (5 μm) with tradename PF-5 NYLON SP 500 available from Daito Kasei, polymethyl silsesquioxane coated with C9-15 fluoroalcohol phosphates with tradename PF-5 TOSPEARL 145 available from Daito Kasei, vinyl dimethicone/methicone silsesquioxane crosspolymer with tradenames KSP series available from ShinEtsu Chemical Co., Ltd., Tokyo Japan, and hardened polyorgano siloxane elastomers with tradenames TREFIL series available from Toray Dow Corning.

### Process for Making Collapsible Water-Containing Capsules

The present invention relates to suitable processes for making the collapsible water-containing capsules as described above in an effective manner, while the physical structures of the capsules are maintained. The process relates to mixing the water phase and the pigment phase, the pigment phase comprising at least a first pigment component having a particle size of less than 1 μm and a hydrophobic surface. For convenience, in this section, the mixing of the water phase and the pigment phase for forming the capsule is referred to as “main mixing”, while mixing of certain compositional components prior to the main mixing is referred to as “premixing”.

As described above, without being bound by theory, it is believed that, by the surface tension of the surface of the first pigment component, the first pigment component aligns at the phase boundary of the water phase, while the particles of the first pigment component bind with each other via van-der-Waals binding. The suitable processes herein are those which provide enough energy to micronize the water phase or maintain the size of the micronized water phase, to allow the first pigment components to align at the phase boundary and form a stable capsule, yet do not provide the shear stress that would immediately destroy the physical structure of the capsule. Preferably avoided are means that apply high shear stress to the capsules, such as high speed agitation, and mechanical mixing means that provide crushing or kneading.

Generally, the water phase and the pigment phase are separately prepared prior to main mixing. The pigment phase may be pulverized to fragmentate any agglomeration which may interfere with the following capsule making process. When gelling agents are incorporated, the gelling agent may be premixed with either the water phase or the pigment phase, depending on the physical properties of the compositional components, and the components of the mixing apparatus. For certain mixing apparatus, as detailed below, which require an atomizing system for delivering the water phase, the water phase may be sprayed as is, or premixed with the gelling agent prior to main mixing. The flow rate of atomizing is adjusted to provide the desired size of the capsule.

In one preferred embodiment, the inner wall of the vessel for main mixing is hydrophobically coated with, for example, silicone or Teflon, to lower the surface energy of the inner wall, and thereby provide the capsule making in an efficient manner. When a final primary package is directly used for main mixing, as detailed below, the inner wall of the final primary package should have a surface energy of 50 dyne/cm or less, preferably 40 dyne/cm or less.

Various mixing apparatus in the art can be used for the main mixing of the present process.

Suitable mixing apparatus herein are the external energy sourcing type or container shaking type. These apparatus are those which do not have a mixing blade or the like within the vessel in which the capsule is made. These apparatus are advantageous in that there is hardly any, or only a controllable amount of shear stress provided during the making process. These apparatus are also advantageous in that the making process is done in a relatively short length of time.

Mixing apparatus of the external energy sourcing type include, but are not limited to, vibratory mixer, and resonant frequency mixer. Vibratory mixers are those that provide convection mixing by impact of vertical shaking motion, gyrostopic oscillating or vibration frequency. Resonant frequency mixers are those that use an oscillator to excite the material for mixing by high efficient energy transfer. Mixing apparatus of the container shaking type are those that provide movement by alternative acceleration and retardation, rather than a rotating movement.

In these external energy sourcing type or container shaking type apparatus, the compositional components for making the capsule are simply filled in the mixing vessel together, and mixed. The mixing vessel is not inverted, and there is no need to supply the water phase via spray or atomization. Thus, these apparatus may be used for providing a process wherein the capsule is directly made in a final primary packaging for consumer use, sometimes called the “make-in-pack” process. Accordingly, in one highly preferred embodiment, the present process relates to the use of a mixing apparatus of the external energy sourcing type or container shaking type, wherein the capsule is to be provided in a final primary packaging for consumer use, wherein the process comprises the steps of:

i) directly supplying the water phase and the pigment phase in the final primary packaging; and
ii) mounting the product of step i) onto the mixing apparatus for making the capsule.

Herein, the final primary packaging means the primary packaging in which the user receives the product, rather than an interim vessel or package which is only used for delivering or filling the product into a final primary package.

Commercially available vibratory mixers highly preferred herein include COROB 200 available from CPS Color, and TSTM Vibratory Mixer and Vibratory Mixer Type 1 available from Tsukishima Techno Machinery Co., Ltd. Commercially available resonant frequency mixers highly preferred herein include Resodyn Acoustic Mixers available from Resodyn Corporation. Container shaking type mixers that do not provide rotating movement are those that provide convection mixing by impact of alternative acceleration or retardation of gyroscopic shaking motion. Commercially available shaker mixers highly preferred herein include TURBULA Shaker Mixer (T2F) and Dyna Mix available from Willy A. Bachofen A G, and COROB M300/CORB and VIBRO available from CPS Color.

Suitable mixing apparatus herein are the fluidizer type, mechanical mixing type and container rotating type. Mixing apparatus of the fluidizer type are those wherein air is delivered for mixing. Fluidizer mixers are advantageous in providing homogenous particles size. Mechanical mixing mixers are, those that have some kind of revolving shaft, ribbon, screw, paddle, or combination thereof. Mixing apparatus of the mechanical mixing type are those which provide low shear mixing including, but not limited to, ribbon blender, screw blender, and paddle mixer. Container rotating mixers are those which provide convention mixing by sliding and falling down impact, shear compaction and revolvement, caused by the rotating movement of the container itself. Mixing apparatus of the container rotating type include but are not limited to, V-mixer, and double conical mixer.

In these fluidizer type, mechanical mixing type or container rotating type apparatus, the water phase is delivered via an atomizing system. The atomizing system can be a sprayer or a misting device, depending on the type of the mixing apparatus.

Commercially available container rotating mixers highly preferred herein include V-blender and Double-conical mixer available from Tokuju Corporation. Commercially available fluidizer mixers highly preferred herein include MULTIPLEX Type MP-01 available from Powrex, and Fluid Bed Granulator available from Glatt. Commercially available mechanical mixing mixers highly preferred herein include Granurex available from Powrex Freund, Ribbon Blender available from Dalton Corporation, Ribbon Blender RB-8.5-05S available from Toyo Hi-Tech Co. Ltd., and paddle mixer Bella Fluidized Zone Mixer available from DYNAMIX AIR Inc.

In another embodiment, the present capsule is provided to the end user as a preparation-at-use product for providing a collapsible water-containing capsule comprising:
(a) a water phase;
(b) a pigment phase comprising at least a first pigment component having a particle size of less than 1 μm and a hydrophobic surface; and
(c) a final primary packaging having an inner wall having a surface tension of 50 dyne/cm or less;
   wherein the water phase and the pigment phase are separately packaged prior to use, and wherein the capsule is made by the steps of;
   i) filling the water phase and the pigment phase into the final primary packaging; and
   ii) manually shaking the product of step i) until the water phase is encapsulated in the pigment phase.

In this embodiment, the capsule making process happens at use by manual shaking of the user. Such preparation-at-use product provides the user of the feeling that the product is freshly made upon use, and/or the amusement of making the product. Alternatively, such preparation-at-use action may be used as an effective demonstration of making the product for market promotion or otherwise.

### Additional Components

The capsules hereof may further contain additional components such as are conventionally used in topical products, e.g., for providing aesthetic or functional benefit to the composition or personal surface, such as sensory benefits relating to appearance, smell, or feel, therapeutic benefits, or prophylactic benefits (it is to be understood that the above-described required materials may themselves provide such benefits). Further, the capsule of the present invention may comprise various skin benefit agents and perfumes in a dissolved or dispersed form in the water phase or attracted within the pigment phase. It is advantageous to deliver such skin benefit agents, and perfumes encompassed in the present collapsible water-containing capsule, for one or more reasons. For those components that are heat sensitive, the present capsule prevents or delays evaporation prior to use. For those components that may be deteriorated or compromised in benefit by coming to contact with the remainder of the personal care composition, the present capsules act as a barrier. Other components may provide a certain sensation upon application and collapsing of the present capsule. When included, the total amount of additional components are kept to no more than about 10% by weight of the capsule.

Powders and pigments that do not meet the definition of the first and second pigment components described above may be included as additional components. Namely, powders and pigments that do not have a hydrophobic surface, and powders and pigments having a particle size of 1 μm or more that have a non-spherical shape such as platelet and needle shape. Such additional powders are preferably not mixed with the pigment phase in the process, but are added after the water phase and pigment phase are mixed to make the capsule. Without being bound by theory, it is believed that separating the additional powders from the initial capsule making process step provides a more stable capsule.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention. Where applicable, ingredients are identified by chemical or CTFA name, or otherwise defined below.

The following are compositions of the present capsule and suitable processes for making such capsules.

TABLE 1
Composition Examples 1-4 in weight percentage

| | | Ex. 1 | Ex. 2 | Ex. 3 | Ex. 4 |
|---|---|---|---|---|---|
| 1 | Titanium Dioxide coated with C9-15 fluoroalcohol phosphates (0.25 μm) *1 | 10 | | | 3 |
| 2 | Titanium Dioxide coated with perfluorooctyl triethoxysilane (0.021 μm) *2 | | 10 | | |
| 3 | Zinc Oxide coated with C9-15 fluoroalcohol phosphates (0.020 μm) *3 | | | | 2 |
| 4 | Yellow Iron Oxide coated with C9-15 fluoroalcohol phosphates (0.435 μm) *4 | 1.386 | | | 1.0 |
| 5 | Red Iron Oxide coated with C9-15 fluoroalcohol phosphates (0.44 μm) *5 | 0.189 | | | 0.1 |
| 6 | Black Iron Oxide coated with C9-15 fluoroalcohol phosphates (0.4 μm) *6 | 0.243 | | | 0.1 |
| 7 | Anhydrous Silicic Acid coated with hexamethylenedisilazane (7 nm) *7 | | | 5 | |
| 8 | Anhydrous Silicic Acid coated with trimethyl silyl (14 nm) *8 | | | | 10 |
| 9 | Sodium Carboxymethyl Starch *9 | 1.5 | 1.5 | | 1.5 |
| 10 | Xanthan Gum *10 | | | 0.01 | 0.01 |
| 11 | Agar *11 | | | 0.5 | |
| 12 | Nylon-12 coated with C9-15 fluoroalcohol phosphates (5 μm) *12 | 6.682 | 7.7 | | |
| 13 | Polymethyl Silsesquioxane coated with C9-15 fluoroalcohol phosphates | | | | 1 |
| | (4.5 μm) *13 | | | | |
| 14 | Talc coated by Methicone (10 μm) *14 | | | | 5.0 |
| 15 | Mica coated with Titanium Dioxide coated with Methicone (40 μm) *15 | | | 12 | |
| 16 | Mica (10 μm) *16 | | 1.85 | | |
| 17 | Titanium Dioxide (0.040 μm) *17 | | | | 1 |
| 18 | Polyoxyethylene Methylpolysiloxane Copolymer *18 | | | 0.5 | |
| 19 | D-delta-tocopherol *19 | | 0.1 | | |
| 20 | Ethylhexyl Methoxycinnamate *20 | | | 0.1 | |
| 21 | Butylene Glycol *21 | 15 | | 10 | |
| 22 | Dipropylene Glycol | | | | 10 |
| 23 | Glycerin | | 5 | 1 | |
| 24 | Ethanol | | 2 | | |
| 25 | Glucosyl Hesperidin *22 | | 0.5 | | |
| 26 | Ascorbic Acid *23 | | 1 | | |
| 27 | Niacinamide *24 | | 2 | | |
| 28 | Mulberry Root Extract *25 | | | | 1 |
| 29 | Panthenol *26 | | 1 | | |
| 30 | Saccharomycopsis Ferment Filtrate *27 | | 10 | | 5 |
| 31 | WATER | 64.7 | 56.9 | 70.59 | 58.89 |
| 32 | EDTA-2NA | | 0.1 | | 0.1 |
| 33 | PRESERVATIVES | 0.3 | 0.3 | 0.3 | 0.3 |
| 34 | Perfume | | 0.05 | | |
| | Total | 100 | 100 | 100 | 100 |

Definitions of Components
*1 Titanium Dioxide coated with C9-15 fluoroalcohol phosphates (0.25 μm): PF-5 TiO2 CR-50 available from Daito Kasei.
*2 Titanium Dioxide coated with perfluorooctyl triethoxysilane (0.021 μm): FHS-12 TiO2 P-25 available from Daito Kasei.
*3 Zinc Oxide coated with C9-15 fluoroalcohol phosphates (0.020 μm): PF-7 ZnO-350 available from Daito Kasei.
*4 Yellow Iron Oxide coated with C9-15 fluoroalcohol phosphates (0.435 μm): PF-5 YELLOW LL-100PD available from Daito Kasei.
*5 Red Iron Oxide coated with C9-15 fluoroalcohol phosphates (0.44 μm): PF-5 RED R-516PD available from Daito Kasei.
*6 Black Iron Oxide coated with C9-15 fluoroalcohol phosphates (0.4 μm): PF-5 BLACK BL-100P available from Daito Kasei.
*7 Anhydrous Silicic Acid coated with hexamethylenedisilazane (7 nm): AEROSIL RX300 from NIPPON AEROSIL.
*8 Anhydrous Silicic Acid coated with trimethyl silyl (14 nm): AEROSIL R202 from NIPPON AEROSIL.
*9 Sodium Carboxymethyl Starch: COVAGEL available from LCW.
*10 Xanthan Gum: Keltrol T available from Kelco.
*11 Agar: INA AGAR from Ina Food.
*12 Nylon-12 coated with C9-15 fluoroalcohol phosphates (5 μm): PF-5 NYLON SP-500 available from Daito Kasei.
*13 Polymethyl Silsesquioxane coated with C9-15 fluoroalcohol phosphates (4.5 μm): PF-5 TOSPEARL 145 available from Daito Kasei.
*14 Talc coated by Methicone (10 μm): SI TALC from Miyoshi Kasei.
*15 Mica coated with Titanium Dioxide coated with Methicone (40 μm): SI FLAMENCO SUPER PEARL from Miyoshi Kasei
*16 Mica (10 μm): SERICITE FSE available from Sanshin Kohkoh.
*17 Titanium Dioxide (0.040 μm): Titanium Dioxide TTO-55 available from Ishihara.
*18 Polyoxyethylene Methylpolysiloxane Copolymer: KF-6018 from ShinEtsu Chemical.
*19 D-delta-tocopherol: D-DELTA-TOCOPHEROL available from EISAI CO., LTD.
*20 Ethylhexyl Methoxycinnamate: PARSOL MCX available from ROCHE VITAMINS JAPAN K.K.
*21 Butylene Glycol: 1,3-Butylene Glycol available from Celanese.
*22 Glucosyl Hesperidin: α-Ghesperidin PS-CC, available from Hayashibara.
*23 Ascorbic Acid: Ascorbic Acid available from ROCHE VITAMINS JAPAN K.K.
*24 Niacinamide: Niacinamide USP available from DSM.
*25 Mulberry Root Extract: Mulberry BG, available from Maruzen Pharmaceuticals.
*26 Panthenol: D-Panthenol USP, available from DSM.
*27 Saccharomycopsis Ferment Filtrate: SK-II Pitera available from Kashiwayama.

### Method of Preparation—Premixing

### 1. Pigment Phase Preparation

Components (1)-(8) and (12)-(13) make the pigment phase. The pigment phase components are mixed using a high speed fluidizing mixer or ribbon blender and further pulverized using a pulvelizer. A de-agglomerated fine powder mixture of the pigment phase is obtained.

### 2. Water Phase Preparation

Components (21)-(33) are the water phase components and other hydrophilic components. For purposes of explanation of the process embodiments below, components (21)-(33) will be collectively referred to as the water phase. The water phase components are mixed using an agitator in the container.

### 3. Others

Components (9)-(11) make the gelling agent. Components (14)-(20) and (34) are additional powders other hydrophobic components, and perfume. The additional powders may be premixed in the same manner as the pigment phase. For purposes of explanation of the process embodiments below, components (14)-(20) and (34) will be collectively referred to as additional powders.

### Method of Preparation—Main Mixing

### Process Example 1

### Vibratory Mixer (Magnetic Vibration/Vibration Motor)

The capsule of any composition of Example 1-4 can be made by Vibratory Mixer Type 1 from TSUKISHIMA TECHNO-MACHINERY Co., Ltd. as follows:

The loading amount of each component is adjusted to make a 10 kg batch size. The pigment phase is transferred to a vibratory mixer vessel (VF-1M, 28 L) at amplitude of vibration (5-50 mm) and oscillation frequency (200-1000 rpm). Under the same mixing condition, the water phase and gelling agent are added into the vessel until formation of capsule. Under the same mixing condition, the additional powders, if any, are added.

### Process Example 2

### Acoustic Resonance Frequency Mixer

The capsule of any composition of Example 1-4 can be made by LabRAM from Resodyn Corporation as follows:

The loading amount of each component is adjusted to make a 300 g batch size. The pigment phase, water phase, and gelling agent are transferred to a mixing container (500 mL) and mixed at 5-80 G acceleration until the formation of capsule. Under the same mixing condition, the additional powders, if any, are added.

### Process Example 3

### Shaker Mixer

The loading amount of each component is adjusted to make a 420 g batch size. The capsule of any composition of Example 1-4 can be made by TURBULA-Shaker from Willy A. Bachofen A G as follows:

The pigment phase, water phase, and gelling agent are transferred to a mixing container (1 L) and mixed at 49-101 rpm until the formation of capsule. Under the same mixing condition, the additional powders, if any, are added.

### Process Example 4

### Fluidizer Mixer

The capsule of any composition of Example 1-4 can be made by MULTIPLEX Type MP-01 from POWREX as follows:

The loading amount of each component is adjusted to make a 750 g batch size. The pigment phase and gelling agent are transferred to the fluidizer system. The water phase is fed into the atomizer, and the atomizer is mounted onto the mixing apparatus. The water phase is fed into the atomizer, and the atomizer is mounted onto the mixing apparatus. The water phase is atomized at 10-80 NL/min in an amount of 20-70 g of water phase/min, while air flow rate of 5-20 m³/min is provided in the fluidizing bed until the formation of capsule. Under the same mixing condition, the additional powders, if any, are added.

### Process Example 5

### Mechanical Mixer

The capsule of any composition of Example 1-4 can be made by Ribbon Blender, RB-8.5-05S from Toyo Hi-Tech Co. Ltd. as follows:

The loading amount of each component is adjusted to make a 1500 g batch size. The pigment phase and gelling agent are transferred to the ribbon blender mixer. The water phase is fed into the atomizer, and the atomizer is mounted onto the mixing apparatus. The water phase is atomized into the ribbon blender at 10-80 NL/min in an amount of 20-70 g of water phase/min, and mixed until the formation of capsule. Under the same mixing condition, the additional powders, if any, are added.

### Process Example 6

### Mechanical Mixer

The capsule of any composition of Example 1-4 can be made by paddle mixer, Bella Fluidized Zone Mixer available from DYNAMIX AIR Inc as follows:

The loading amount of each component is adjusted to make a 3600 g batch size. The pigment phase and gelling agent are transferred to the paddle mixer. The water phase is fed into the atomizer, and the atomizer is mounted onto the mixing apparatus. The water phase is atomized into the paddle mixer at 10-80 NL/min in an amount of 100-500 g of water phase/min, and mixed until the formation of capsule. Under the same mixing condition, the additional powders, if any, are added.

### Process Example 7

### Acoustic Resonance Frequency Mixer

The capsule of Example 1 can be made by make-in-pack method using LabRAM from Resodyn Corporation as follows:

The loading amount of each component is adjusted to make a 10 g batch size. The pigment phase, water phase, and gelling agent are transferred to a final primary packaging made of polyethylene terephthalate (30 g, surface tension of inner wall less than 40 dyne/cm), mounted onto the mixing apparatus, and mixed at 5-80 G acceleration until the formation of capsule. Process Example 8. Shaker Mixer

The capsule of Example 1 can be made by make-in-pack method using TURBULA-Shaker from Willy A. Bachofen AG as follows:

The loading amount of each component is adjusted to make a 10 g batch size. The pigment phase, water phase, and gelling agent are transferred to a final primary packaging made of polyethylene terephthalate (30 g, surface tension of inner wall less than 40 dyne/cm), mounted onto the mixing apparatus, and mixed at 49-101 rpm until the formation of capsule.

### Method of Use

The capsules of Composition Examples 1 and 4 made by any of the Process Examples 1-6 above are stable under normal storage conditions as well as normal mixing processes, however, collapses upon application. The capsules of Composition Example 1 made by any of the Process Examples 7-8 are also stable under normal storage conditions as well as normal mixing processes, however, collapses upon application.

Products of Example 1 made by any of the Process Examples 1-8 above and Example 4 made by any of the Process Examples 1-6 above are useful as foundation products. Products of Example 2 made by any of the Process Examples 1-6 above are useful as whitening powders. Products of Example 3 made by any of the Process Examples 1-6 above are useful as point make-up products. These products, when applied to the skin, provide good fit on the skin, favorable moisturizing and cooling sensation, even coverage, and long wear on the skin.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a collapsible water-containing capsule having a water phase encapsulated or dispersed in a pigment phase, the pigment phase comprising at least a first pigment component having a particle size of less than 1 μm and a hydrophobic surface;
wherein the water phase and the pigment phase are mixed by a mixing apparatus selected from the group consisting of external energy sourcing type and container shaking type.

2. The process of claim 1 wherein the mixing apparatus is the external energy sourcing type selected from the group consisting of vibratory mixer, and resonant frequency mixer.

3. The process of claim 1 wherein the mixing apparatus is the container shaking type that provides movement by alternative acceleration and retardation.

4. The process of claim 1 wherein the capsule further comprises a gelling agent, the gelling agent being premixed with the water phase, prior to mixing with the pigment phase.

5. The process of claim 1 wherein the capsule further comprises a gelling agent, the gelling agent being premixed with the pigment phase, prior to mixing with the water phase.

6. The process of claim 1 wherein the capsule is to be provided in a final primary packaging for consumer use, wherein the process comprises the steps of:
i) directly supplying the water phase and the pigment phase in the final primary packaging; and
ii) mounting the product of step i) onto the mixing apparatus for making the capsule.

7. A collapsible water-containing capsule made by the process of any of claims 1.

8. A process for making a collapsible water-containing capsule having a water phase encapsulated or dispersed in a pigment phase, the pigment phase comprising at least a first pigment component having a particle size of less than 1 μm and is surface coated with a lipophobic hydrophobic coating material;
wherein the water phase and the pigment phase is mixed by a mixing apparatus selected from the group consisting of fluidizer type, mechanical mixing type and container rotating type.

9. The process of claim 8 wherein the mixing apparatus is the fluidizer type wherein air is delivered for mixing.

10. The process of claim 8 wherein the mixing apparatus is the mechanical mixing type which provides low shear mixing.

11. The process of claim 10 wherein the mixing apparatus is the mechanical mixing type selected from the group consisting of ribbon blender, screw blender, and paddle mixer.

12. The process of claim 8 wherein the mixing apparatus is the container rotating type selected from the group consisting of V-mixer, and double conical mixer.

13. The process of claim 8 wherein the water phase is delivered in the mixing apparatus via an atomizing system.

14. The process of claim 13 wherein the capsule further comprises a gelling agent, the gelling agent being premixed with the water phase and atomized with the water phase.

15. The process of claim 13 wherein the capsule further comprises a gelling agent, the gelling agent being premixed with the pigment phase, prior to mixing with the water phase.

16. A collapsible water-containing capsule made by the process of any of claims 8.

17. A preparation-at-use product for providing a collapsible water-containing capsule comprising:
(a) a water phase;
(b) a pigment phase comprising at least a first pigment component having a particle size of less than 1 μm and a hydrophobic surface; and
(c) a final primary packaging having an inner wall having a surface tension of 50 dyne/cm or less;
wherein the water phase and the pigment phase are separately packaged prior to use, and wherein the capsule is made by the steps of:
i) filling the water phase and the pigment phase into the final primary packaging; and
ii) manually shaking the product of step i) until the water phase is encapsulated in the pigment phase.
